(19) United States
(12) Patent Application Publication
(10) Pub. No.: US 2003/0051716 A1
(43) Pub. Date: Mar. 20, 2003

(54) Method and electronic control unit for controlling the regeneration of a fuel vapour accumulator in internal combustion engines

(76) Inventors: Gholamabas Esteghlal, Ludwisburg (DE); Dieter Lederer, Ludwigsburg (DE)

Correspondence Address: KENYON & KENYON, ONE BROADWAY, NEW YORK, NY, 10004, US

(21) Appl. No.: 10/129,470

(22) PCT Filed: Aug. 31, 2001
(86) PCT No.: PCT/DE01/03292

(30) Foreign Application Priority Data
Sep. 4, 2000 (DE) 100 43 862.8

(51) Int. Cl. F02M 25/08; B60K 41/04; F02D 41/14

(52) U.S. Cl. 123/698; 123/520; 477/111

(57) ABSTRACT

A method is for controlling a tank venting valve between an internal combustion engine and a fuel vapor storage unit, with the stored fuel vapor being supplied from the fuel vapor storage unit to the internal combustion engine when the tank venting valve is open. A distinction is made between active and inactive tank venting phases, and the purge rate is preset during active tank venting by a purge rate setting arrangement as a function of operating parameters of the engine and/or the tank venting system. If the duration of the inactive tank venting phase exceeds a minimum duration, the purge rate in the subsequent active tank venting phase is temporarily limited to a value below the rate preset by the purge rate setting arrangement.

### BACKGROUND INFORMATION

Methods for controlling the regeneration of an intermediate fuel vapor storage unit in internal combustion engines are known from U.S. Pat. No. 4,683,861.

The intermediate fuel vapor storage unit can be implemented in the form of an active charcoal filter. It absorbs fuel vapor evaporating in the fuel tank. The active charcoal filter is regenerated by purging it with air. The purging air flows through the active charcoal filter, where it absorbs fuel, and is supplied to the internal combustion engine in the form of fuel-laden regeneration gas. The regeneration of the active charcoal filter by purging it with air is accomplished, for example, by opening a tank venting valve between the active charcoal filter and the intake manifold of the internal combustion engine. The intake manifold vacuum acts in this case as the driving force for purging the filter via a fresh air opening. The flow of the fuel-laden regeneration gas follows the pressure gradient, reaching the internal combustion engine via the tank venting valve.

According to known methods, regeneration takes place only in certain engine operating states. In engines with gasoline direct injection, operation with homogeneous distribution of the air/fuel mixture in the combustion chambers is especially suitable, since the regeneration gas also enters the combustion chambers in the form of a homogeneous mixture of air and fuel.

The lean mode of operation with stratified charge distribution favored in gasoline direct injection engines is less suitable, however, because the premixed regeneration gas interferes with the injection jet-controlled charge stratification.

As is known from U.S. Pat. No. 6,012,435, in the case of long-lasting stratified-charge operation, regeneration of the active charcoal filter does not, under some circumstance, take place for a longer period of time if the engine is operated in stratified mode for a longer period of time. If this period exceeds a threshold, the engine switches to homogeneous mode, according to the cited U.S. publication, to allow regeneration of the active charcoal filter.

Depending on the amount of fuel vapor that has been absorbed by the active charcoal filter prior to regeneration, the filter may be laden with more or less fuel. Consequently, the regeneration gas may contain a greater or smaller amount of fuel following regeneration after a longer inactive tank venting phase.

To equalize the fuel volume that is supplied to the internal combustion engine along with the regeneration gas, the amount of fuel flowing via the injectors is usually reduced.

If the regeneration gas is very rich in fuel at the time regeneration begins, the entire fuel volume supplied to the engine is large enough to produce unwanted HC emissions.

Against this background, the object of the present invention is to provide an emission-neutral method for supplying regeneration gas in internal combustion engines with tank venting, thereby reducing unwanted HC emissions, without impairing driving comfort or adversely affecting engine torque. Another object is to maximize the purging volume under the given ancillary conditions.

These objects are achieved with the features of claim 1.

In particular, the present invention describes a method for controlling a tank venting valve between an internal combustion engine and a fuel vapor storage unit, with the stored fuel vapor being supplied from the fuel vapor storage unit to the internal combustion engine when the tank venting valve is open. According to the method, a distinction is made between active and inactive tank venting phases, and, when tank venting is active, the opening state of the tank venting valve is preset by a fuel setting means as a function of first operating parameters of the engine and/or the tank venting system and limited by a purge rate limiting means as a function of second operating parameters, or preset by a purge rate setting means as a function of second operating parameters and/or limited by a flow rate factor as a function of third operating parameters.

According to one embodiment, the first operating parameters of the engine and/or the tank venting system include values for the speed and at least one of the following operating parameters:

Torque

Necessary fuel mass

Intake air temperature

Mixture composition and

Charge distribution in the combustion chamber

According to another embodiment, the second operating parameters include the integral value of the mass flow via the tank venting valve.

According to a further embodiment, the third operating parameters depend at least on the speed and the quotient of the intake manifold pressure and the ambient pressure.

According to a further embodiment, a distinction is made between the active and inactive tank venting phases, and, if the duration of the inactive tank venting phase exceeds a minimum duration, the opening state of the tank venting valve is temporarily limited in the subsequent active tank venting phase to a value below the value preset by the purge rate limiting means or the purge rate setting means.

The present invention also relates to a method for controlling a tank venting valve between an internal combustion engine and a fuel vapor storage unit, with the stored fuel vapor being supplied from the fuel vapor storage unit to the internal combustion engine when the tank venting valve is open, with the internal combustion engine being coupled with a torque converter whose transmission ratio is changeable during internal combustion engine operation, and in which a torque supplied by the internal combustion engine is temporarily reduced during a change in the transmission ratio, wherein the tank venting valve is temporarily closed upon a change in the transmission ratio and a reduction in the torque supplied by the internal combustion engine.

According to a further embodiment, the purge rate is defined as a quotient of the mass flow via the tank venting valve and the entire mass flow into the intake manifold.

According to a further embodiment, the purge rate limitation is canceled if the period during which the reduction was active exceeds a predetermined threshold.

According to a further embodiment, the purge rate limitation is canceled if a measure of the regeneration gas volume flowing to the engine exceeds a threshold value.

According to a further embodiment, the above-mentioned measure is formed as a function of the integral of the mass flow via the tank venting valve or as a function of the integral over the purge rate.

According to a further embodiment, the method is used in an internal combustion engine with gasoline direct injection, with tank venting being limited even if undesirably high lambda deviations occur during active tank venting.

If the internal combustion engine is operated with a stratified charge, according to a further embodiment, the relative change in the low-pass-filtered lambda setpoint is analyzed; and tank venting is limited on account of unwanted high lambda deviations during active tank venting only if the relative change in the low-pass-filtered lambda setpoint is smaller than a predetermined threshold value.

The present invention also relates to an electronic control device for carrying out at least one of the methods and embodiments.

According to the methods, a distinction is made between active and inactive tank venting phases, and, in the case of active tank venting, the purge rate is preset by fuel setting means as a function of operating parameters of the engine and/or the tank venting system and limited by a purge rate limiting means or preset by a purge rate setting means. If the duration of the inactive tank venting phase exceeds a minimum duration, the purge rate in the subsequent active tank venting phase is temporarily limited to a value below the rate preset by the purge rate limiting means or purge rate setting means.

The method according to the present invention advantageously prevents a change in the load state of the active charcoal filter that occurred during a long inactive tank venting phase from resulting in an unwanted increase in the entire fuel flow to the internal combustion engine. As a result, it is possible to avoid an unwanted increase in HC emissions following long inactive tank venting phases without having to reduce the wanted high regeneration rates following shorter inactive tank venting phases.

Because the limitation is only temporary, it is also possible to avoid unwanted limiting of the regeneration rates during longer active tank venting phases.

On the whole, this encourages a wanted high regeneration rate without increased HC emissions during the transition from inactive to active tank venting.

Exemplary embodiments of the present invention are explained below on the basis of the drawing.

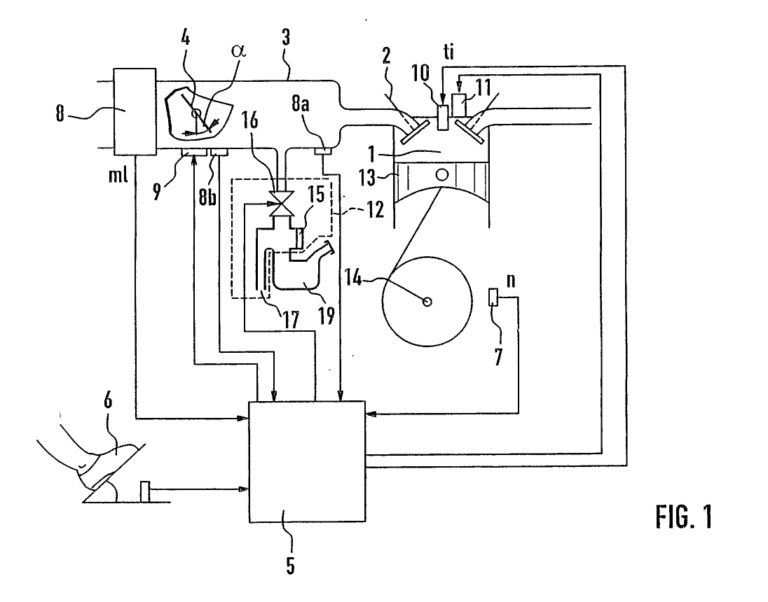

FIG. 1 shows the technical background of the present invention.

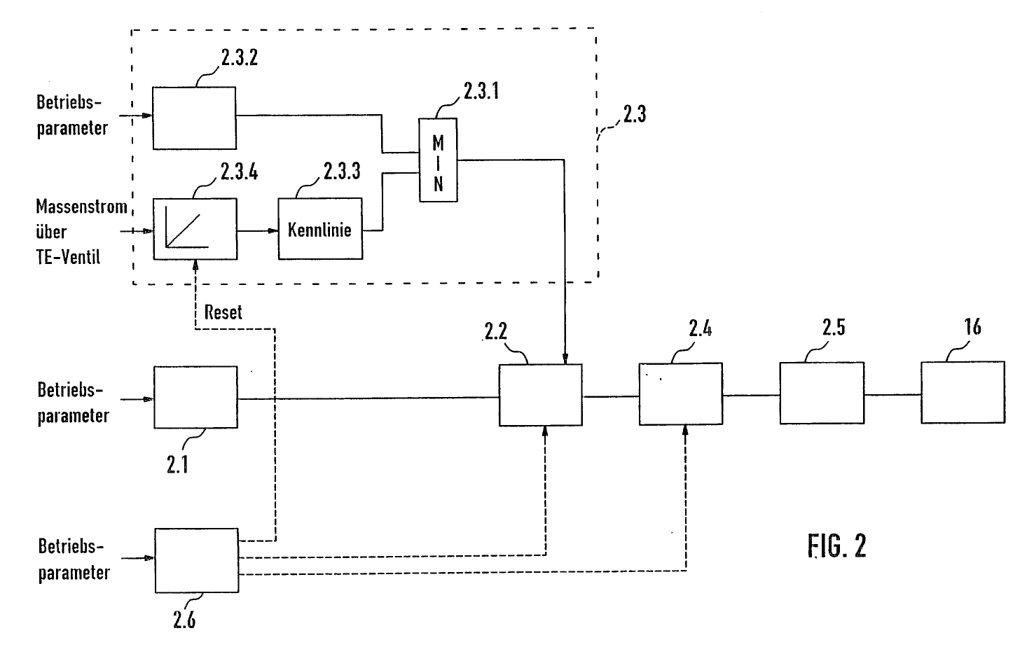

FIG. 2 describes an exemplary embodiment of the present invention in the form of function blocks.

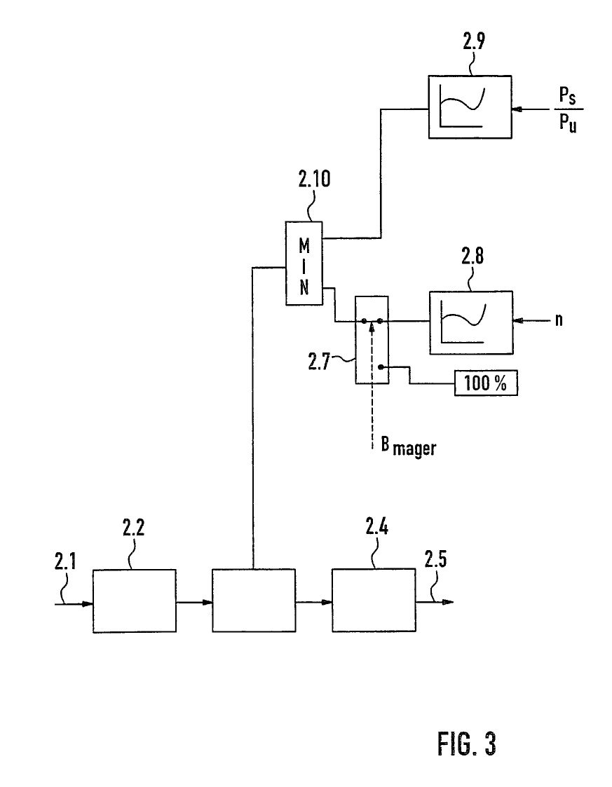

FIG. 3 shows a modification of the exemplary embodiment illustrated in FIG. 2.

Reference number 1 in FIG. 1 represents the combustion chamber of a cylinder of an internal combustion engine. The inflow of air into the combustion chamber is controlled by an intake valve 2. The air is drawn in by an intake manifold 3. The intake air volume can be varied by a throttle valve 4, which is controlled by a control unit 5. Signals corresponding to the torque request by the driver, e.g., via the position of a gas pedal 6, a signal indicating engine speed n of an engine speed sensor 7 and a signal indicating volume ml of the intake air by an air flow sensor 8, are supplied to the control unit.

An intake manifold pressure sensor 8a and/or a throttle valve position sensor 8b for measuring the air flow is provided in addition or as an alternative to air flow sensor 8.

In the discussion below, the term “charge detection” in place of “air flow measuring” is used. The term “charge” paraphrases the air volume relative to the charge of a single cylinder. In a first approximation, this is the measured air volume, divided by the number of cylinders and speed and thus normalized to a stroke.

Based on these and possibly other input signals corresponding to additional parameters of the internal combustion engine, such as intake air and coolant temperature, control unit 5 forms output signals for setting throttle valve angle alpha by an actuator 9 and for controlling a fuel injector 10 that meters the fuel into the engine combustion chamber. The control unit also controls ignition triggering via an ignition device 11.

The control unit also controls a tank venting system 12 as well as other functions for the efficient combustion of the air/fuel mixture in the combustion chamber. The gas force resulting from combustion is converted to a torque by pistons 13 and crank mechanism 14.

Tank venting system 12,includes an active charcoal filter 15, which communicates via corresponding lines or connections with the tank, ambient air and the intake manifold of the internal combustion engine, with a tank venting valve 16 being provided in the line to the intake manifold.

Active charcoal filter 15 stores fuel evaporating in tank 19. As tank venting valve 11 is opened by control unit 6, air is drawn in from environment 17 through the active charcoal filter, which releases the stored fuel into the air. This air/fuel mixture, which is also known as tank venting mixture or regeneration gas, influences the composition of the entire mixture supplied to the internal combustion engine, which is further determined by metering fuel via fuel metering device 10, which is adjusted to the indrawn air volume. In extreme cases, the fuel drawn in via the tank venting system may be in a proportion of approximately one third to one half of the entire fuel volume.

FIG. 2 shows a function block diagram illustrating an embodiment of the method according to the present invention for controlling the tank venting valve.

Block 2.1 represents a fuel rate setting means that may be implemented, for example, in the form of a characteristics map storage unit.

The fuel rate is first determined as a function of the engine operating point. The fuel portion is converted to a purge rate in block 2.2 and limited to a maximum value dependant on the operating point by a purge rate limiting means 2.3.

The fuel rate may be defined as the quotient of the fuel supplied via the tank venting valve and the entire fuel supplied to the internal combustion engine, and the purge rate may be defined as the quotient of the mass flow via the tank venting valve and the entire mass flow into the intake manifold.

The operating point is defined by engine operating parameters such as speed, torque, necessary fuel mass, intake air temperature, mixture composition and charge distribution in the combustion chamber. These operating parameters are partially preset by the control unit and/or detected by sensors. For example, the control unit determines whether the engine is to operate in homogeneous charge distribution mode or in stratified charge distribution mode. The torque is formed by control unit-detected operating parameters such as speed and intake air volume, intake air temperature, throttle valve angle, and intake manifold pressure. The mixture composition may be calculated from quantities present in the control unit, such as the fuel flow via the injectors and the cylinder charge, or it may be determined metrologically by an exhaust gas analyzing probe.

It is important to note that the engine may process larger fuel rates and purge rates, and thus larger volumes of regeneration gas, in some operating points than others, and that a fuel rate setting means and a purge rate setting means therefore preset suitable fuel and purge rates as a function of the operating point.

The purge rate is converted in block 2.2. to a control pulse duty factor for tank venting valve 16. The calculation may incorporate, for example, mass flow mdk via the engine throttle valve to first determine a desired mass flow via the tank venting valve, based on the purge rate. This function is represented by block 2.4. For example, if the purge rate is 20% and the mass flow via the throttle valve is 4 kg/hour, this yields a desired mass flow of 1 kg/hour via the tank venting valve. An opening pulse duty factor corresponding to this flow rate for controlling the tank venting valve is obtainable, for example, from a characteristics map that additionally includes the pressure difference between the intake manifold and the tank venting system. This pressure difference, in turn, may be estimated on the basis of intake manifold pressure psaug, which is either measured or modeled in the control unit.

According to the present invention, the control signal determined in this manner is additionally limited temporarily.

A minimum selection (block 2.3.1) between the maximum value of the purge rate selected from a characteristics map (block 2.3.2) and a limit value of the purge rate from a block 2.3.3 is suitable for this purpose.

The limit value may be obtained from a characteristic curve (block 2.3.3) that is addressed by the integral value of the mass flow via the tank venting valve (block 2.3.4), with the integral value being reset to zero by controller 2.6 during inactive tank venting phases that exceed a minimum duration.

It is particularly advantageous to take into account the integral value of the mass flow via the tank venting valve, because it is a measure of the purge volume passing through the active charcoal filter. If this value exceeds a minimum, which may correspond, for example, to the volume in the line between the active charcoal filter and the intake manifold, abrupt changes in the HC concentration in the regeneration gas should no longer be expected, and it is no longer necessary to limit the purge rate.

The mass flow via the tank venting valve is determinable, for example, from the real purge rate supplied also to block 2.4 and mass flow mdk via the throttle valve.

According to the present invention, the reduction is triggered when the length of an operating phase without opening of the tank venting valve exceeds a preselected value. The changeover between active and inactive tank venting is controlled by a sequence control system 2.6. In particular, the sequence control system detects the mass flow via the tank venting valve, and thus the length of the inactive tank venting phases, and compares it to a preselected threshold value. If the period of inactivity exceeds the duration defined by the preselected threshold value, the integral value of the mass flow via the tank venting valve is reset to zero. As a result, the purge rate limitation remains in effect during the next active tank venting phase until the integral value of the mass flow exceeds the minimum value preset in characteristic curve 2.3.3.

As an alternative, the purge rate itself or its maximum value may be multiplicatively reduced instead of using the minimum selection.

The period during which the reduction was in effect may be used as a criterion for the duration of the reduction. If this period-exceeds a preset threshold, the reduction is cancelled.

As an alternative to the determination of the purge rate from the preset fuel rate, the purge rate may be preset directly.

The tank venting limitation goes beyond the interventions mentioned above in the following operating states:

A reduction torque that may result in injection interruptions is activated in the case of gear changes in automatic transmissions. To avoid an increase in HC emissions, the tank venting valve closes upon receipt of the gear change request and opens again after a delay when injection resumes.

Operation data acquisition specific: If undesirably high lambda deviations occur during tank venting, for example due to the use of an unbuffered active charcoal filter, tank venting is immediately limited by regulated manipulation of the limit value. To avoid manipulation of the limit value regulation following an operating point change in stratified mode, it is necessary to distinguish between an operating point change and lambda deviations, which must also be reliably detected. For this purpose, the relative change in the low-pass-filtered lambda setpoint is analyzed and weighted, so that only low values result in manipulation of the limit value, while high values are interpreted as an operating point change.

Operation data acquisition specific: Due to the poor combustion characteristics of the spatially homogeneous regeneration gas in stratified mode, opening of the tank venting valve is limited as a function of speed. In FIG. 3, a switch switches a limiting characteristics map 2.8, instead of a fixed value (100%), to a minimum selection 2.10 in lean mode (control signal: Bmager). A further limiting characteristics map 2.9 is addressed by the quotient of pressures Ps (intake manifold pressure) and pressure in tank venting system Pu (approximately equal to the ambient pressure). Block 2.10 makes a minimum selection between the output quantities of the characteristics maps. A flow rate factor is formed in block 2.11. In the structure shown in FIG. 2, block 2.11 is positioned between block 2.2 and block 2.4 so that intervention via the flow rate factor has an additional or supplementary limiting effect.

Operation data acquisition specific: To regenerate the NOx storage catalytic converter, which is necessary at regular intervals, the engine is operated with a rich mixture that can reach lambda values of up to 0.7. Because the measuring accuracy of the lambda probe is insufficient in this range, the regeneration gas charge cannot be adapted during simultaneous tank venting. To avoid switching to controlled tank venting with a very low purge rate, which ordinarily takes place within this lambda range, the tank venting purge rate is reduced by an applicable factor when the NOx storage catalytic converter is regenerated with lambda values below a certain threshold.

Operation data acquisition specific: Switching between the different operating modes (homogeneous, homogeneous-lean and stratified) must take place smoothly. To minimize possible interference potential on the part of the tank venting system, the regeneration gas charge is divided into low, medium and high segments and only certain operating modes and changes are allowed as a function thereof. Independently thereof, the fuel portion of the tank venting is limited to an applicable value upon switching between different operating modes relative to the combustion process (homogeneous, stratified), i.e., opening of the tank venting valve must be reduced prior to switching. A common configuration is: High charge: homogeneous mode; no switching;

Medium charge: homogeneous, homogeneous-lean, homogeneous-stratified modes; switching; Low charge: all operating modes; switching.

The limitations described above achieve a largely emission-neutral tank venting process that does not impair driving comfort. They also avoid unwanted HC emissions resulting from a tank venting strategy that is imprecisely tuned to the operating states, as well as unwanted influences on torque; at the same time the purge rate is maximized under the given ancillary conditions.

What is claimed is:

1. A method for controlling a tank venting valve between an internal combustion engine and a fuel vapor storage unit, with the stored fuel vapor being supplied from the fuel vapor storage unit to the internal combustion engine when the tank venting valve is open; and with a distinction being made between active and inactive tank venting phases; and with the opening state of the tank venting valve during the active tank venting phase being preset by fuel setting means as a function of first operating parameters of the engine and/or the tank venting system, and
limited by a purge rate limiting means as a function of second operating parameters or preset by a purge rate setting means as a function of second operating parameters;
and/or limited by a flow rate factor as a function of third operating parameters.

2. The method according to claim 1, wherein the first operating parameters of the engine and/or the tank venting system include values for speed and at least one of the following operating parameters:
torque
necessary fuel mass
intake air temperature
mixture composition and
charge distribution in the combustion chamber

3. The method according to claim 1,
wherein the second operating parameters include the integral value of the mass flow via the tank venting valve.

4. The method according to claim 1,
wherein the third operating parameters depend at least on the speed and the quotient of the intake manifold pressure and the ambient pressure.

5. The method according to claim 1,
wherein a distinction is made between active and inactive tank venting phases; and, when the duration of the inactive tank venting phase exceeds a minimum duration, the opening state of the tank venting valve in the subsequent active tank venting phase is temporarily limited to a value below the value preset by the purge rate limiting means or purge rate setting means.

6. A method for controlling a tank venting valve between an internal combustion engine and a fuel vapor storage unit, with the stored fuel vapor being supplied from the fuel vapor storage unit to the internal combustion engine when the tank venting valve is open; with the internal combustion engine being coupled with a torque converter whose transmission ratio is variable during operation of the internal combustion engine; and in which the torque supplied by the internal combustion engine is temporarily reduced during a change in the transmission ratio,
wherein the tank venting valve is temporarily closed following a change in the transmission ratio and reduction in the torque supplied by the internal combustion engine.

7. The method according to claim 1,
wherein the purge rate is defined as the quotient of the mass flow via the tank venting valve and the entire mass flow into the intake manifold.

8. The method according to claim 1,
wherein the purge rate limitation is canceled when the period during which the reduction was active exceeds a predetermined threshold.

9. The method according to claim 1,
wherein the purge rate limitation is canceled when a measure of the regeneration gas volume flowing to the engine exceeds a threshold value.

10. The method according to claim 9,
wherein the above-mentioned measure depends on the integral of the mass flow via the tank venting valve or on the integral over to the purge rate.

11. The method according to one of the preceding claims,
wherein the method is carried out in an internal combustion engine with gasoline direct injection; and tank venting is limited even when unwanted high lambda deviations occur during active tank venting.

12. The method according to claim 10,
wherein, when the internal combustion engine is operated with a stratified charge, the relative change in the low-pass-filtered lambda setpoint is analyzed; and tank venting is limited as a result of unwanted high lambda deviations during active tank venting only if the relative change in the low-pass-filtered lambda setpoint is less than a predetermined threshold value.

13. An electronic control device for carrying out the methods according to claims 1-12.
